(19) United States
(12) Patent Application Publication
(10) Pub. No.: US 2023/0325608 A1
(43) Pub. Date: Oct. 12, 2023

(54) VOICE PROCESSING DEVICE FOR PROCESSING VOICE SIGNAL AND VOICE PROCESSING SYSTEM COMPRISING SAME

(71) Applicant: AMOSENSE CO., LTD., Cheonan-si, Chungcheongnam-do (KR)

(72) Inventor: Jungmin KIM, Cheonan-si (KR)

(73) Assignee: AMOSENSE CO., LTD., Cheonan-si, Chungcheongnam-do (KR)

(21) Appl. No.: 18/022,255

(22) PCT Filed: Aug. 18, 2021
(86) PCT No.: PCT/KR2021/010939

§ 371 Date: Feb. 20, 2023

(30) Foreign Application Priority Data
Aug. 19, 2020 (KR) 10-2020-0103909
Sep. 29, 2020 (KR) 10-2020-0126504

(51) Int. Cl. G06F 40/47; G10L 17/22; H04R 3/00; G10L 17/02; H04R 1/40; G10L 21/028; H04R 1/10

(52) U.S. Cl. CPC G06F 40/47; G10L 17/22; H04R 3/005; H04R 2420/07; H04R 1/406; G10L 21/028; H04R 1/1041; G10L 17/02

(57) ABSTRACT

A voice processing device is disclosed. The voice processing device comprises: a voice data receiving circuit receives input voice data associated with voices of speakers; a memory stores starting language data; a voice data output circuit outputs output voice data associated with the voices of the speakers; and a processor generates a control command for outputting the output voice data, wherein the processor uses the input voice data to generate first speaker position data indicating a position of a first speaker of the speakers and first output voice data associated with a voice of the first speaker, reads first source language data corresponding to the first speaker position data with reference to the memory, and transmits, to the voice data output circuit, a control command for outputting the first output voice data to a translation environment for translating a first source language indicated by the first starting language data.

### TECHNICAL FIELD

Embodiments of the present disclosure relate to a voice processing device for processing a voice signal and a voice processing system including the voice processing device.

### BACKGROUND ART

A microphone is a device which recognizes voice, and converts the recognized voice into a voice signal that is an electrical signal. In case that a microphone is disposed in a space in which a plurality of speakers are located, such as a meeting room or a classroom, the microphone receives all voices from the plurality of speakers, and generates voice signals associated with the voices from the plurality of speakers.

In case that the plurality of speakers pronounce at the same time, it is required to separate the voice signals representing only the voices of the individual speakers. Further, in case that the plurality of speakers pronounce in different languages, in order to easily translate the voices of the plurality of speakers, it is required to grasp the original languages (i.e., source languages) of the voices of the plurality of speakers, and there are problems in that it requires a lot of time and resources to grasp the languages of the corresponding voices only with the features of the voices themselves.

### SUMMARY OF INVENTION

An object of the present disclosure is to provide a voice processing device, which can judge the positions of speakers by using input voice signals and generate output voice signals representing voices of the speakers by using the input voice signals, and a voice processing system including the voice processing device.

Another object of the present disclosure is to provide a voice processing device, which can judge the positions of speakers by using voice signals, determine source languages corresponding to the positions of the speakers, and transmit voice signals to translation environments for translating the determined source languages, and a voice processing system including the voice processing device.

Still another object of the present disclosure is to provide a voice processing device, which can generate translation results for voices of speakers by using separated voice signals associated with the voices of the speakers and transmit the generated translation results to corresponding codeless earphones, and a voice processing system including the voice processing device.

A voice processing device according to embodiments of the present disclosure includes: a voice data receiving circuit configured to receive input voice data associated with voices of speakers; a memory configured to store source language data; a voice data output circuit configured to output output voice data associated with the voices of the speakers; and a processor configured to generate a control command for outputting the output voice data, wherein the processor is configured to: generate first speaker position data representing a position of a first speaker among the speakers and first output voice data associated with a voice of the first speaker by using the input voice data, read first source language data corresponding to the first speaker position data with reference to the memory, and transmit, to the voice data output circuit, a control command for outputting the first output voice data to a translation environment for translating a first source language indicated by the first source language data.

A voice processing system according to embodiments of the present disclosure includes: a plurality of codeless earphones and a voice processing device, wherein each of the plurality of codeless earphones includes a microphone unit configured to generate voice signals associated with voices pronounced by speakers, a communication unit configured to transmit the voice signals, and a speaker unit configured to reproduce voices, and wherein the voice processing device includes: a communication circuit configured to receive the voice signals transmitted from the plurality of codeless earphones; a voice processing circuit configured to generate a first separated voice signal associated with a voice of a first speaker among the speakers from first voice signals transmitted from a first codeless earphone among the plurality of codeless earphones, and generate a first translated voice signal by translating the first separated voice signal; a memory; and a communication circuit configured to transmit the first translated voice signal to the remaining codeless earphones excluding the first codeless earphone among the plurality of codeless earphones.

The voice processing device according to embodiments of the present disclosure can grasp the position of the speaker by using the voice signal, and can distinguish of which speaker the voice signal corresponds to the voice through the position of the speaker. Accordingly, even if plural speakers pronounce voices at the same time, the voice separating device can distinguish and separate the voices by speakers.

Since the voice processing device according to embodiments of the present disclosure can generate a separated voice signal associated with the voice from the position of a specific voice source based on the position of the voice source of the voice, it is possible to generate the voice signal with the minimum effects of ambient noise.

The voice processing device according to embodiments of the present disclosure can not only extract voices of respective speakers from transmitted voice signals but also judge source languages that are languages before the voices are translated based on the voice source positions of the voices and provide the results of translation by translating the corresponding voices based on the judged source languages.

The voice processing device according to embodiments of the present disclosure can generate the results of translation for voices of speakers by using separated voice signals associated with the voices of the respective speakers, and transmit the generated results of translation to corresponding codeless earphones.

### BRIEF DESCRIPTION OF DRAWINGS

FIG. 1 illustrates a voice processing system according to embodiments of the present disclosure.

FIG. 2 illustrates a voice processing device according to embodiments of the present disclosure.

FIGS. 3 to 6 are diagrams explaining an operation of a voice processing device according to embodiments of the present disclosure.

FIG. 7 is a flowchart illustrating a method for operating a voice processing device according to embodiments of the present disclosure.

FIG. 8 is a diagram illustrating an operation of a voice processing device according to embodiments of the present disclosure.

FIGS. 9 and 10 are diagrams explaining an operation of a voice processing device according to embodiments of the present disclosure.

FIG. 11 illustrates a voice processing system according to embodiments of the present disclosure.

FIG. 12 illustrates a codeless earphone according to embodiments of the present disclosure.

FIG. 13 illustrates a voice processing device according to embodiments of the present disclosure.

FIG. 14 is a diagram explaining an operation of a voice processing device according to embodiments of the present disclosure.

FIGS. 15 to 18 are diagrams explaining a translation function of a voice processing device according to embodiments of the present disclosure.

FIG. 19 is a flowchart illustrating an operation of a voice processing device according to embodiments of the present disclosure.

### DESCRIPTION OF EMBODIMENTS

Hereinafter, embodiments of the present disclosure will be described with reference to the accompanying drawings.

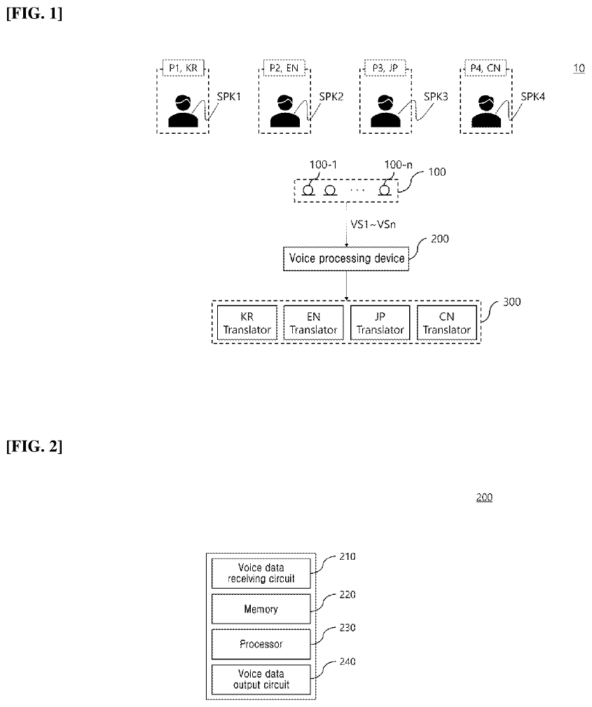

FIG. 1 illustrates a voice processing system according to embodiments of the present disclosure. Referring to FIG. 1, a voice processing system 10 according to embodiments of the present disclosure may provide translations for voices of speakers SPK1 to SPK4. The speakers SPK1 to SPK4 may be positioned at positions P1 to P4, respectively. According to embodiments, the speakers SPK1 to SPK4 positioned at the positions P1 to P4 may pronounce the voices in languages of the speakers SPK1 to SPK4, respectively. For example, the first speaker SPK1 positioned at the first position P1 may pronounce the voice in a first language (e.g., Korean (KR)), and the second speaker SPK2 positioned at the second position P2 may pronounce the voice in a second language (e.g., English (EN)). The third speaker SPK3 positioned at the third position P3 may pronounce the voice in a third language (e.g., Japanese (JP)), and the fourth speaker SPK4 positioned at the fourth position P4 may pronounce the voice in a fourth language (e.g., Chinese (CN)).

According to embodiments, the voice processing system 10 may determine the positions of the speakers SPK1 to SPK4 based on the voices of the speakers SPK1 to SPK4, and translate the voices of the speakers SPK1 to SPK4 from languages (e.g., source languages) corresponding to the determined positions to other languages (e.g., target languages).

That is, since the voice processing system 10 according to embodiments of the present disclosure determines the languages (e.g., source languages) of the voices of the speakers SPK1 to SPK4 based on the positions of the speakers SPK1 to SAPK4, it is possible to translate the voices of the speakers SPK1 to SPK4 without separately recognizing the languages of the voices of the speakers SPK1 to SPK4, and thus time and resources required for the translation can be reduced.

The voice processing system 10 may include a plurality of microphones 100 configured to receive the voices of the speakers SPK1 to SPK4, a voice processing device 200, and a translation environment 300.

The voices of the speakers SPK1 to SPK4 may be received by the plurality of microphones 100.

The plurality of microphones 100 may receive the voices of the speakers SPK1 to SPK4 positioned at the positions P1 to P4, respectively, and generate voice signals VS1 to VSn associated with the voices of the speakers SPK1 to SPK4. For example, a first microphone 100-1 may receive the voices of the speakers SPK1 to SPK4, and generate a first voice signal VS1 associated with the voices of the speakers SPK1 to SPK4. The first voice signal VS1 generated by the first microphone 100-1 may correspond to the voices of one or more speakers SPK1 to SPK4.

Meanwhile, the voice signal described in the description may be an analog type signal or digital type data. According to embodiments, since the analog type signal and the digital type data may be converted into each other, and include substantially the same information even if the signal type (analog or digital) is changed, the digital type voice signal and the analog type voice signal are interchangeably used in describing embodiments of the present disclosure.

Hereinafter, embodiments of the present disclosure will be described with reference to the accompanying drawings.

FIG. 1 illustrates a voice processing system according to embodiments of the present disclosure. Referring to FIG. 1, the voice processing system 10 according to embodiments of the present disclosure may provide translations for the voices of the speakers SPK1 to SPK4. According to embodiments, the voice processing system 10 may determine the positions of the speakers SPK1 to SPK4 based on the voices of the speakers SPK1 to SPK4, and translate the voices of the speakers SPK1 to SPK4 from the languages (e.g., source languages) corresponding to the determined positions to the other languages (e.g., target languages).

That is, since the voice processing system 10 according to embodiments of the present disclosure determines the source languages of the voices of the speakers SPK1 to SPK4 in accordance with the positions of the speakers SPK1 to SAPK4, it is possible to translate the voices of the speakers SPK1 to SPK4 without separately recognizing the languages of the voices of the speakers SPK1 to SPK4, and thus the time and resources required for the translation can be reduced.

The voice processing system 10 may include the plurality of microphones 100 configured to receive the voices of the speakers SPK1 to SPK4, the voice processing device 200, and the translation environment 300.

The plurality of microphones 100 may receive the voices of the speakers SPK1 to SPK4 positioned at the positions P1 to P4, respectively, and convert the voices of the speakers SPK1 to SPK4 into the voice signals VS1 to VSn that are electrical signals. For example, the first microphone 100-1 may receive the voices of the speakers SPK1 to SPK4, and generate the first voice signal VS1 associated with the voices of the speakers SPK1 to SPK4. The first voice signal VS1 generated by the first microphone 100-1 may correspond to the voices of one or more speakers SPK1 to SPK4.

The plurality of microphones 100 may output the voice signals VS1 to VSn. According to embodiments, the plurality of microphones 100 may transmit the voice signals VS1 to VSn to the voice processing device 200. For example, the plurality of microphones 100 may transmit the voice signals VS1 to VSn to the voice processing device 200 in accordance with a wired or wireless method.

The plurality of microphones 100 may be composed of beamforming microphones, and receive voices multi-directionally. According to embodiments, the plurality of microphones 100 may be disposed to be spaced apart from one another to constitute one microphone array, but embodiments of the present disclosure are not limited thereto.

Each of the plurality of microphones 100 may be a directional microphone configured to receive the voice in a certain specific direction, or an omnidirectional microphone configured to receive the voice in all directions.

The voice processing device 200 may receive input voice data associated with the voices of the speakers SPK1 to SPK4, generate output voice data associated with the voices of the speakers SPK1 to SPK4 by using the input voice data, and transmit the output voice data to the translation environment 300.

According to embodiments, the input voice data may be the voice signals VS1 to VSn. For example, the voice processing device 200 may receive the voice signals VS1 to VSn transmitted from the plurality of microphones 100, and obtain the input voice data associated with the voices of the speakers SPK1 to SPK4 from the voice signals VS1 to VSn.

Meanwhile, although it is assumed in the description that the voice processing device 200 obtains the input voice data associated with the voices of the speakers SPK1 to SPK4 through reception of the voice signals VS1 to VSn from the plurality of microphones 100, according to embodiments, the plurality of microphones 100 may be included in the voice processing device 200.

The voice processing device 200 may be a computing device having an arithmetic processing function. According to embodiments, the voice processing device 200 may be implemented by a computer, a notebook computer, a mobile device, a smart phone, or a wearable device, but is not limited thereto. For example, the voice processing device 200 may include at least one integrated circuit having the arithmetic processing function.

The voice processing device 200 may determine the positions of the speakers SPK1 to SPK4 (i.e., positions of voice sources) by using the input voice data associated with the voices of the speakers SPK1 to SPK4. According to embodiments, the voice processing device 200 may generate speaker position data representing the positions of the speakers SPK1 to SPK4 from the input voice data associated with the voices of the speakers SPK1 to SPK4 based on at least one of distances among the plurality of microphones 100, differences among times when the plurality of microphones 100 receive the voices of the speakers SPK1 to SPK4, respectively, and levels of the voices of the speakers SPK1 to SPK4.

The voice processing device 200 may separate the input voice data in accordance with the positions of the speakers (i.e., positions of the voice sources) based on the speaker position data representing the positions of the speakers SPK1 to SPK4. For example, the voice processing device 200 may group the input voice data by the determined positions of the speakers.

For example, in case that the first speaker SPK1 and the second speaker SPK2 pronounce as overlapping each other in time, the voices of the first speaker SPK1 and the second speaker SPK2 overlap each other, and thus the input voice data may also include the voice data associated with the voice of the first speaker SPK1 and the voice data associated with the voice of the second speaker SPK2. As described above, the voice processing device 200 may generate the speaker position data representing the respective positions of the first speaker SPK1 and the second speaker SPK2 from the input voice data associated with the voice of the first speaker SPK1 and the voice of the second speaker SPK2, and generate first output voice data representing the voice of the first speaker SPK1 and second output voice data representing the voice of the second speaker SPK2 from the input voice data based on the speaker position data. In this case, the first output voice data may be the voice data having the highest correlation with the voice of the first speaker SPK1 among the voices of the speakers SPK1 to SPK4. In other words, the voice component of the first speaker SPK1 may have the highest proportion among voice components included in the first output voice data.

The voice processing device 200 may determine source languages corresponding to the positions of the speakers SPK1 to SPK4 by using the input voice data, and transmit the output voice data to the translation environment 300 for translating the determined source languages into the target languages. For example, if the position of the speaker that is determined based on the input voice data is the first position P1, the voice processing device 200 may transmit the output voice data to the translation environment 300 for translating the source language (e.g., Korean (KR)) corresponding to the first position P1.

The voice processing device 200 according to embodiments of the present disclosure may generate the speaker position data representing the positions of the speakers SPK1 to SPK4 by using the input voice data of the speakers SPK1 to SPK4, determine the source languages of the voices of the speakers SPK1 to SPK4 in accordance with the positions of the speakers SPK1 to SPK4, and transmit the output voice data to the translation environment 300 for translating the source languages.

Accordingly, the voice processing device 200 may transmit the voice data to the translation environment for translating the languages of the voices of the speakers SPK1 to SPK4 even without separately recognizing the languages of the voices of the speakers SPK1 to SPK4.

According to embodiments, the voice processing device 200 may process the input voice data associated with the voices of the speakers SPK1 to SPK4. The voice processing device 200 may generate text data including texts associated with the voices of the speakers SPK1 to SPK4 by using the input voice data, and match and store the generated text data with the speaker position data.

Further, the voice processing device 200 may convert the input voice data associated with the voices of the speakers SPK1 to SPK4 into the text data, and transmit the text data to the translation environment 300.

The translation environment 300 may means an environment or a system that provides translations for the languages. According to embodiments, the translation environment 300 may receive the output voice data associated with the voices of the speakers SPK1 to SPK4 from the voice processing device 200, and output data associated with the voices of the speakers SPK1 to SPK4 translated into other languages. For example, the translation environment 300 may provide the translations about Korean, English, Japanese, and Chinese, which correspond to the languages of the speakers SPK1 to SPK4.

The translation environment 300 may include translators 310 to 340. Each translator 310 may mean a device that can convert data expressed in a source language into data expressed in a target language, or a terminal configured to provide the voice to an interpreter who performs language translation.

According to embodiments, the translation environment 300 may include a device that supports a language translation function. For example, the translation environment 300 may include a device that can receive the voice data, convert the voice data into the text data, and convert the language of the text data into another language. For example, the translation environment 300 may include a device that can receive the text data corresponding to the voice, and convert the language of the text data into another language.

According to embodiments, the translation environment 300 may include a terminal configured to provide the voices of the speakers SPK1 to SPK4 to the interpreter who performs the language translation. For example, the translation environment 300 may include a terminal that can reproduce the voice corresponding to the voice data to the interpreter by using the voice data. The terminal may be, for example, a speaker or an earphone.

FIG. 2 illustrates a voice processing device according to embodiments of the present disclosure. Referring to FIG. 2, the voice processing device 200 may include a voice data receiving circuit 210, a memory 220, a processor 230, and a voice data output circuit 240.

The voice data receiving circuit 210 may receive input voice data associated with voices of speakers SPK1 to SPK4. According to embodiments, the voice data receiving circuit 210 may receive the input voice data associated with the voices of speakers SPK1 to SPK4 in accordance with a wired or wireless communication method.

According to embodiments, the voice data receiving circuit 210 may include an analog-to-digital converter (ADC), receive analog type voice signals VS1 to VSn from a plurality of microphones 100, convert the voice signals VS1 to VSn into digital type input voice data, and store the converted input voice data.

According to embodiments, the voice data receiving circuit 210 may include a communication circuit that is communicable in accordance with the wireless communication method, and receive the input voice data through the communication circuit.

The memory 220 may store therein data required to operate the voice processing device 200. According to embodiments, the memory 220 may include at least one of a nonvolatile memory and a volatile memory.

The memory 220 may store position data representing registered positions, and source language data corresponding to the position data. According to embodiments, the position data and the source language data may be matched and stored in the memory 220.

The source language data may represent a source language of the voice (or input voice data) of the speaker positioned at the position corresponding to the position data. For example, as illustrated in FIG. 1, the source language data corresponding to the position data representing a first position P1 may represent the source language (e.g., Korean) of the voice pronounced at the first position P1. That is, the source language data may represent the source language of the voice (or input voice data) pronounced at the position corresponding to the position data.

The processor 230 may control the overall operation of the voice processing device 200. According to embodiments, the processor 230 may generate a control command for controlling the operations of the voice data receiving circuit 210, the memory 220, and the voice data output circuit 240, and transmit the control command to the voice data receiving circuit 210, the memory 220, and the voice data output circuit 240.

The processor 230 may be implemented by an integrated circuit having an arithmetic processing function. For example, the processor 230 may include a central processing unit (CPU), a micro controller unit (MCU), a digital signal processor (DSP), a graphics processing unit (GPU), an application specific integrated circuit (ASIC), or a field programmable gate array (FPGA), but the embodiments of the present disclosure are not limited thereto.

The processor 230 may judge the positions (i.e., voice source positions of the voices) of the speakers SPK1 to SPK4 by using the input voice data associated with the voices of the speakers SPK1 to SPK4, and generate speaker position data representing the positions of the speakers SPK1 to SPK4. For example, the processor 230 may store the speaker position data in the memory 220.

The processor 230 may generate the speaker position data representing the positions of the speakers SPK1 to SPK4 from the input voice data associated with the voices of the speakers SPK1 to SPK4 based on at least one of distances among the plurality of microphones 100, differences among times when the plurality of microphones 100 receive the voices of the speakers SPK1 to SPK4, respectively, and levels of the voices of the speakers SPK1 to SPK4.

The processor 230 may separate the input voice data in accordance with the positions of the speakers (i.e., positions of the voice sources) based on the speaker position data representing the positions of the speakers SPK1 to SPK4. For example, the voice processing device 200 may match and store the voice data separated in accordance with the positions with the corresponding speaker position data.

According to embodiments, the processor 230 may generate the speaker position data representing the respective positions of the first speaker SPK1 and the second speaker SPK2 from the input voice data associated with the voices of the first speaker SPK1 and the second speaker SPK2, and generate the first output voice data associated with the voice of the first speaker SPK1 and the second output voice data associated with the voice of the second speaker SPK2 from the input voice data based on the speaker position data. For example, the processor 230 may match and store the first output voice data with the first speaker position data, and match and store the second output voice data with the second speaker position data.

The processor 230 may determine the source languages of the voices of the speakers SPK1 to SPK4 by using the speaker position data. According to embodiments, with reference to the memory 220, the processor 230 may determine the position data corresponding to the speaker position data of the speakers SPK1 to SPK4, determine the source language data matched with the determined position data, and determine the languages indicated by the determined source language data as the source languages of the voices of the speakers SPK1 to SPK4. For example, the processor 230 may match and store the (output or input) voice data associated with the voices of the speakers SPK1 to SPK4 with the source language data representing the source languages of the voices.

According to embodiments, the processor 230 may generate the control command for transmitting the output voice data to the translation environment 300 for translating the source languages of the voices of the speakers SPK1 to SPK4.

The voice data output circuit 240 may output the output voice data associated with the voices of the speakers SPK1 to SPK4. According to embodiments, the voice data output circuit 240 may output the output voice data associated with the voices of the speakers SPK1 to SPK4 in accordance with the wired or wireless communication method.

According to embodiments, the voice signal output circuit 250 may include a communication circuit, and transmit the output voice data to an external device.

The voice data output circuit 240 may transmit the voice data to the translation environment 300 for translating the source languages corresponding to the positions of the speakers SPK1 to SPK4 into the target languages in response to the control command

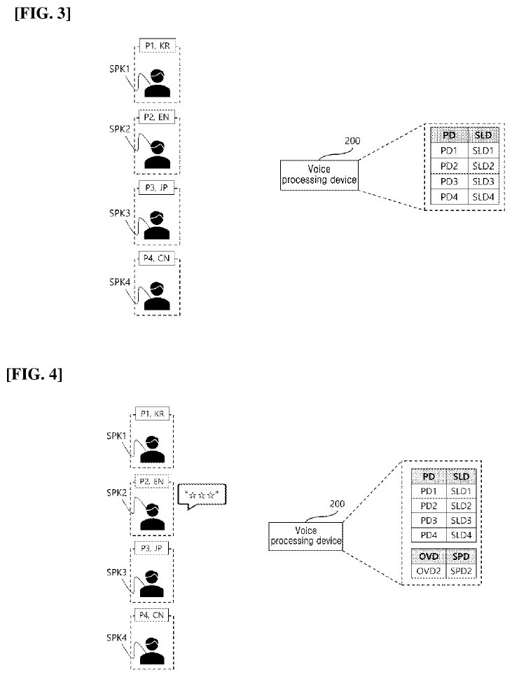

FIGS. 3 to 6 are diagrams explaining an operation of a voice processing device according to embodiments of the present disclosure.

Referring to FIG. 3, the first speaker SPK1 may pronounce the voice in Korean (KR) at the first position P1, the second speaker SPK2 pronounce the voice in English (EN) at the second position P2, the third speaker SPK3 may pronounce the voice in Japanese (JP) at the third position P3, and the fourth speaker SPK4 pronounce the voice in Chinese (CN) at the fourth position P4. That is, the source language of the voice of the first speaker SPK1 may be Korean (KR), the source language of the voice of the second speaker SPK2 may be English (EN), the source language of the voice of the third speaker SPK3 may be Japanese (JP), and the source language of the voice of the fourth speaker SPK4 may be Chinese (CN).

The voice processing device 200 may store position data PD1 to PD4 and source language data SLD1 to SLD4 corresponding to the position data PD1 to PD4. The position data PD1 to PD4 may represent predefined positions of speakers, and the source language data SLD1 to SLD4 may represent source languages of the speakers positioned at the corresponding positions. For example, in case of FIG. 3, the first position data PD1 may represent the first position P1, the first source language data SLD1 may represent Korean (KR), the second position data PD2 may represent the second position P2, and the second source language data SLD2 may represent English (EN).

Referring to FIG. 4, if the second speaker SPK2 pronounces a voice “⋆⋆⋆” in English (EN), the voice processing device 200 may receive input voice data corresponding to the voice “⋆⋆⋆” of the second speaker SPK2. For example, the plurality of microphone 100 may generate voice signals VS1 to VSn corresponding to the voice “⋆⋆⋆”, and the voice processing device 200 may receive the voice signals VS1 to VSn corresponding to the voice “⋆⋆⋆” of the second speaker SPK2, and generate the input voice data from the voice signals VS1 to VSn.

The voice processing device 200 may generate second speaker position data SPD2 representing the position of the voice source of the voice “⋆⋆⋆”, that is, the position of the second speaker SPK2, by using the input voice data associated with the voice “⋆⋆⋆” of the second speaker SPK2.

The voice processing device 200 may generate second output voice data OVD2 associated with the voice “⋆⋆⋆” of the second speaker SPK2 by using the input voice data associated with the voice “⋆⋆⋆” of the second speaker SPK2. For example, the voice processing device 200 may match and store the second output voice data OVD2 with the second speaker position data SPD2.

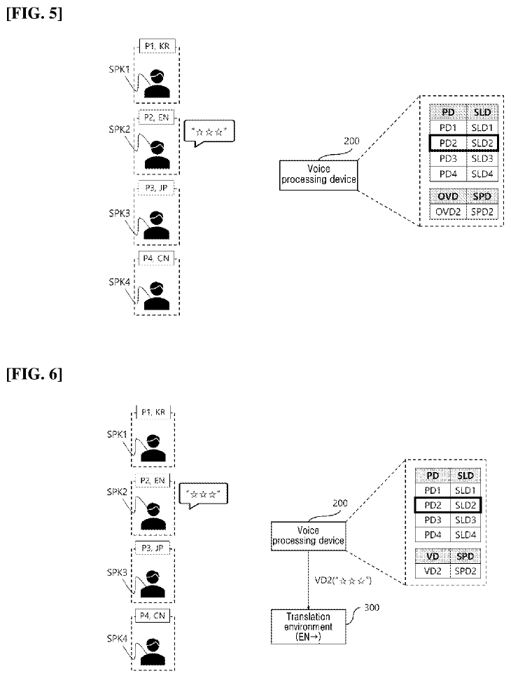

Referring to FIG. 5, the voice processing device 200 may read, from the memory 220, the second source language data SLD2 representing the source language of the voice “⋆⋆⋆” of the second speaker SPK2 based on the second speaker position data SPD2 of the second speaker SPK2.

According to embodiments, the voice processing device 200 may determine the second position data PD2 corresponding to the second speaker position data SPD2 among the position data PD1 to PD4 stored in the memory 220. For example, the voice processing device 200 may determine the position data (e.g., second position data PD2) representing the same or similar position as or to the position of the second speaker position data SPD2 among the position data PD1 to PD4. Thereafter, the voice processing device 200 may read the second source language data SLD2 corresponding to the second position data PD2 from the memory 220.

Accordingly, the voice processing device 200 may determine the source language of the voice “⋆⋆⋆” of the second speaker SPK2 based on the second source language data SLD2.

Referring to FIG. 6, the voice processing device 200 may transmit the second output voice data OVD2 associated with the voice “⋆⋆⋆” of the second speaker SPK2 to the translation environment 300.

According to embodiments, the voice processing device 200 may transmit the second output voice data OVD2 associated with the voice “⋆⋆⋆” of the second speaker SPK2 to the translation environment 300 for translating the source language (e.g., English (EN)) of the voice “⋆⋆⋆” of the second speaker SPK2. For example, the voice processing device 200 may convert the second output voice data OVD2 into text data that is expressed in the source language (e.g., English (EN)) of the voice “⋆⋆⋆” of the second speaker SPK2, and transmit the converted text data to the translation environment 300.

For example, the voice processing device 200 may transmit the second output voice data OVD2 to an English translation device that can perform the English translation. For example, the voice processing device 200 may transmit the second output voice data OVD2 to a terminal (e.g., speaker) that provides the voice to an interpreter who can perform the English translation.

The voice processing device 200 according to embodiments of the present disclosure may determine the source languages of the voices of the speakers SPK1 to SPK4 in accordance with the positions of the speakers SPK1 to SPK4, and transmit the voice data associated with the voices of the speakers SPK1 to SPK4 to the translation environment for translating the determined source language. Accordingly, the voice processing device 200 can judge the source languages of the voices of the speakers SPK1 to SPK4 in accordance with the positions of the speakers SPK1 to SPK4 even without separate analysis (e.g., pitch analysis) or learning of the voices of the speakers SPK1 to SPK4, and thus the time and resources required for the translation can be reduced.

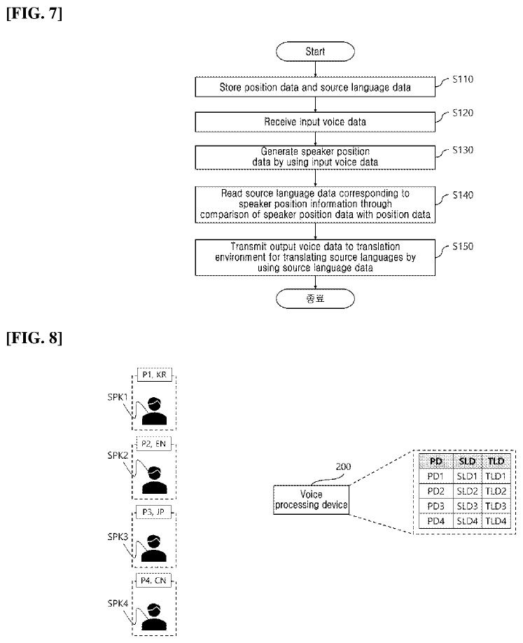

FIG. 7 is a flowchart illustrating a method for operating a voice processing device according to embodiments of the present disclosure. Referring to FIG. 7, the voice processing device 200 may store the position data and the source language data (S110). According to embodiments, the voice processing device 200 may store the position data and the source language data corresponding to the position data in the memory 220. For example, the source language data may represent the source languages of the voices (or voice data) of the speakers who are positioned at the positions corresponding to the position data.

The voice processing device 200 may receive the input voice data associated with the voices of the speakers SPK1 to SPK4 (S120). The voice processing device 200 may store the received input voice data.

For example, the voice processing device 200 may receive the analog type voice signals from the plurality of microphones 100, and obtain the input voice data from the voice signals. For example, the voice processing device 200 may receive the input voice data in accordance with the wireless communication method.

The voice processing device 200 may generate the speaker position data representing the positions of the speakers SPK1 to SPK4 by using the input voice data (S130).

The voice processing device 200 may calculate the positions of the voice sources of the voices associated with the input voice data by using the input voice data. Since the positions of the voice sources are just the positions of the speakers SPK1 to SPK4, the voice processing device 200 may generate the calculated positions of the voice sources as the speaker position data of the speakers SPK1 to SPK4.

The voice processing device 200 may generate the output voice data associated with the voices of the speakers SPK1 to SPK4 by using the input language data. For example, the voice processing device 200 may generate the output voice data associated with only the voices pronounced at the calculated positions of the speakers based on the input voice data.

The voice processing device 200 may compare the speaker position data with the position data, and read the source language data corresponding to the speaker position data (S140).

According to embodiments, the voice processing device 200 may determine the position data corresponding to the speaker position data among the stored position data, and read the source language data corresponding to the determined position data from the memory 220. As described above, since the position data and the corresponding source language data are matched and stored in the memory 220, the voice processing device 200 may determine the source language data representing the source languages corresponding to the positions of the speakers SPK1 to SPK4 by using the speaker position data.

The voice processing device 200 may transmit the output voice data to the translation environment for translating the source languages by using the source language data (S150).

According to embodiments, the voice processing device 200 may transmit the output voice data to the translation environment for translating the source languages represented by the source language data.

For example, the voice processing device 200 may transmit the output voice data to a translation device configured to translate the source language indicated by the read source language data among a plurality of translation devices configured to translate several source languages, respectively.

For example, in case of the examples illustrated in FIGS. 3 to 6, the voice processing device 200 may transmit the output voice data to the translation device configured to translate English corresponding to the source language of the language of the second speaker SPK2 among the plurality of translation devices configured to translate Korean, English, Japanese, and Chinese.

FIG. 8 is a diagram illustrating an operation of a voice processing device according to embodiments of the present disclosure. Referring to FIG. 8, the voice processing device 200 may store position data PD1 to PD4, source language data SLD1 to SLD4 corresponding to the position data PD1 to PD4, and target language data TLD1 to TLD4.

The target language data TLD1 to TLD4 may represent target languages of the voices of the speakers positioned at corresponding positions. For example, the target languages may be differently set by speakers SPK1 to SPK4, but are not limited thereto.

As compared with FIGS. 3 to 6, the voice processing device 200 described with reference to FIG. 8 may read the target language data TLD1 to TLD4 in addition to the source language data SLD1 to SLD4 corresponding to the speaker position data.

According to embodiments, the voice processing device 200 may compare the speaker position data with the position data, and read the source language data SLD1 to SLD4 corresponding to the speaker position data and the target language data TLD1 to TLD4. For example, the voice processing device 200 may determine the position data corresponding to the speaker position data among the stored position data, and read the source language data SLD1 to SLD4 corresponding to the determined position data and the target language data TLD1 to TLD4 from the memory 220.

The voice processing device 200 may transmit the second output voice data OVD2 associated with the voice “⋆⋆⋆” of the second speaker SPK2 to the translation environment 300 for translating the source language (e.g., English (EN)) of the voice “⋆⋆⋆” of the second speaker SPK2 into the target language (e.g., Korean (KR)).

The voice processing device 200 according to embodiments of the present disclosure may determine the source languages of the voices of the speakers SPK1 to SPK4 and the target languages in accordance with the positions of the speakers SPK1 to SPK4, and transmit the voice data associated with the voices of the speakers SPK1 to SPK4 to the translation environment for translating the determined source languages into the target languages.

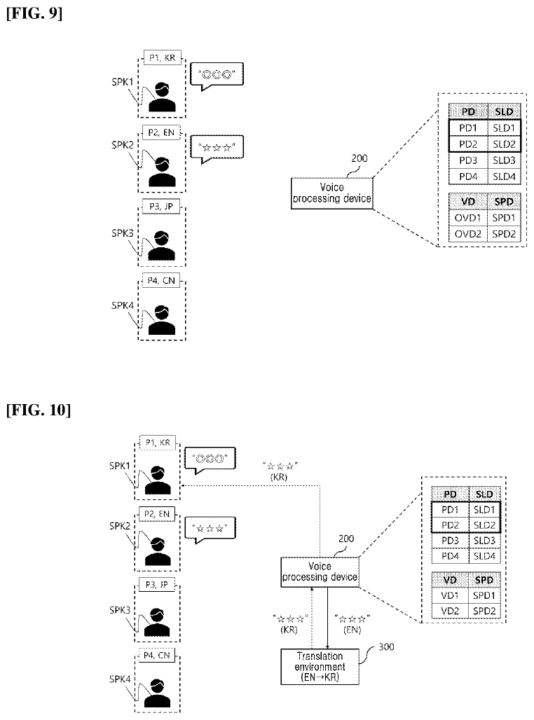

FIGS. 9 and 10 are diagrams explaining an operation of a voice processing device according to embodiments of the present disclosure. Referring to FIG. 9, if the first speaker SPK1 pronounces a voice “⊚⊚⊚”, and the second speaker SPK2 pronounces a voice “⋆⋆⋆” in English (EN), the voice processing device 200 may receive the first input voice data associated with the voice “⊚⊚⊚” of the first speaker SPK1 and the input voice data corresponding to the voice “⋆⋆⋆” of the second speaker SPK2.

According to embodiments, the voice processing device 200 may receive the input voice data associated with the voice “⊚⊚⊚” of the first speaker SPK1 and the voice “⋆⋆⋆” of the second speaker SPK2, generate speaker position data SPD1 and SPD2 representing the positions of the first speaker SPK1 and the second speaker SPK2 from the input voice data, and generate first output voice data OVD1 associated with the voice “⊚⊚⊚” of the first speaker SPK1 and second output voice data OVD2 associated with the voice “⋆⋆⋆” of the second speaker SPK2 from the input voice data based on the speaker position data SPD1 and SPD2.

For example, the voice processing device 200 may match and store the first speaker position data SPD1 with the first output voice data OVD1, and match and store the second speaker position data SPD2 with the second output voice data OVD2.

The voice processing device 200 may read, from the memory 220, the first source language data SLD1 representing the source language of the voice “⊚⊚⊚” of the first speaker SPK1 based on the first speaker position data SPD1 of the first speaker SPK1. Further, the voice processing device 200 may read, from the memory 220, the second source language data SLD2 representing the source language of the voice “⋆⋆⋆” of the second speaker SPK2 based on the second speaker position data SPD2 of the second speaker SPK2. For example, as described above, the voice processing device 200 may determine the position data (e.g., first position data PD1) representing the same or similar position as or to the position of the first speaker position data SPD1 among the position data PD1 to PD4 stored in the memory 220, and read, from the memory 220, the first source language data SLD1 corresponding to the first position data PD1.

Accordingly, the voice processing device 200 may determine the source language of the voice “⊚⊚⊚” of the first speaker SPK1 and the source language of the voice “⋆⋆⋆” of the second speaker SPK2 based on the source language data SLD1 and SLD2. For example, the voice processing device 200 may match and store the first output voice data OVD1 associated with the voice “⊚⊚⊚” of the first speaker SPK1 with the first source language data SLD1, and match and store the second output voice data OVD2 associated with the voice “⋆⋆⋆” of the second speaker SPK2 with the second source language data SLD2.

Further, the voice processing device 200 may determine the source language of the voice “⊚⊚⊚” of the first speaker SPK1 and the target language of the voice “⋆⋆⋆” of the second speaker SPK2 based on the source language data SLD1 and SLD2. According to embodiments, the voice processing device 200 may determine the target languages of the voices of the speakers SPK1 to SPK4 based on the source languages of the remaining speakers excluding the speakers SPK1 to SPK4 themselves.

For example, the voice processing device 200 may set the target language of the voice “⋆⋆⋆” of the second speaker SPK2 as the source language (e.g., Korean) of the voice “⊚⊚⊚” of the first speaker SPK1 excluding the second speaker SPK2 himself/herself. Further, for example, the voice processing device 200 may set the target language of the voice “⊚⊚⊚” of the first speaker SPK1 as the source language (e.g., English) of the voice “⋆⋆⋆” of the second speaker SPK2 excluding the first speaker SPK1 himself/herself.

Referring to FIG. 10, the voice processing device 200 may transmit the second output voice data OVD2 associated with the voice “⋆⋆⋆” of the second speaker SPK2 to the translation environment 300. According to embodiments, the voice processing device 200 may transmit the second output voice data OVD2 associated with the voice “⋆⋆⋆” of the second speaker SPK2 to the translation environment 300 for translating the source language (e.g., English (EN)) of the voice “⋆⋆⋆” of the second speaker SPK2 into the target language (e.g., Korean (KR)).

The voice processing device 200 may transmit the second output voice data OVD2 associated with the voice “⋆⋆⋆” that is expressed in English (EN) to the translation environment 300, and receive the translation result of the second output voice data OVD2 from the translation environment 300.

According to embodiments, the voice processing device 200 may convert the second output voice data OVD2 into text data that is expressed in the source language (e.g., English (EN)) of the voice “⋆⋆⋆” of the second speaker SPK2, and transmit the converted text data to the translation environment 300. Further, the voice processing device 200 may receive the text data that is expressed in the target language (e.g., Korean (KR) of the voice “⋆⋆⋆” from the translation environment 300, and provide the data (voice data or text data) that is expressed in the target language (e.g., Korean (KR)) of the voice “⋆⋆⋆” to the first speaker SPK1 by using the text data.

The voice processing device 200 according to embodiments of the present disclosure may determine the source languages of the voices of the speakers SPK1 to SPK4 in accordance with the positions of the speakers SPK1 to SPK4, and transmit the voice data associated with the voices of the speakers SPK1 to SPK4 to the translation environment for translating the determined source languages. Accordingly, the voice processing device 200 can judge the source languages of the voices of the speakers SPK1 to SPK4 in accordance with the positions of the speakers SPK1 to SAPK4 even without separate analysis (e.g., pitch analysis and the like) or learning of the voices of the speakers SPK1 to SPK4, and thus time and resources required for the translation can be reduced.

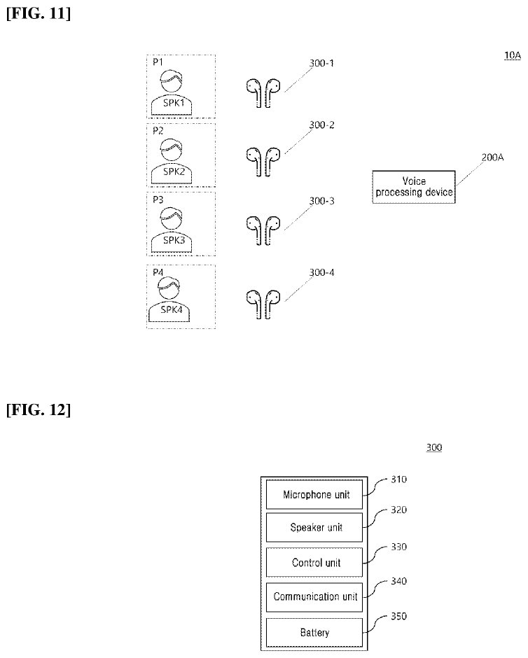

FIG. 11 illustrates a voice processing system according to embodiments of the present disclosure. Referring to FIG. 11, a voice processing system 10A may include a voice processing device 100 and codeless earphones 300-1 to 300-4. As compared with FIG. 1, the voice processing system 10A of FIG. 11 is different from that of FIG. 1 on the point that it includes the codeless earphones 300-1 to 300-4.

The codeless earphones 300-1 to 300-4 may receive the voices of the speakers, and transmit voice signals associated with the voices of the speakers to the voice processing device 200. Further, the codeless earphones 300-1 to 300-4 may reproduce the voice signal transmitted from the voice processing device 200.

The codeless earphones 300-1 to 300-4 are wireless type earphones, and may interwork with or may be connected to the voice processing device 200 in a wireless method. According to embodiments, the codeless earphones 300-1 to 300-4 may send and receive signals with the voice processing device 200 in accordance with a wireless communication method, such as Bluetooth, WiFi, ZigBee, RFID, or NFC. For example, the codeless earphones 300-1 to 300-4 may be true wireless stereo (TWS) earphones.

Each of the codeless earphones 300-1 to 300-4 may include a left earphone and a right earphone.

According to embodiments, the codeless earphones 300-1 to 300-4 may be devices worn by the speakers SPK1 to SPK4. For example, the first codeless earphone 300-1 may be worn by the first speaker SPK1, the second codeless earphone 300-2 may be worn by the second speaker SPK2, the third codeless earphone 300-3 may be worn by the third speaker SPK3, and the fourth codeless earphone 300-4 may be worn by the fourth speaker SPK4.

Meanwhile, although FIG. 1 illustrates that each of the codeless earphones 300-1 to 300-4 is composed of two earphone units, the embodiments of the present disclosure are not limited thereto.

The codeless earphones 300-1 to 300-4 may generate voice signals in response to the voices generated in a space, and transmit the generated voice signals to the voice processing device 200. According to embodiments, the codeless earphones 300-1 to 300-4 may generate the voice signals associated with the voices of the speakers SPK1 to SPK4 in response to the voices of the speakers SPK1 to SPK4, and transmit the voice signals to the voice processing device 200.

For example, the codeless earphones 300-1 to 300-4 may include a plurality of microphones.

The codeless earphones 300-1 to 300-4 may output the voice signals transmitted from the voice processing device 200 in accordance with an auditory method. According to embodiments, the codeless earphones 300-1 to 300-4 may reproduce the voices corresponding to the transmitted voice signals.

The voice processing device 200 may receive the voice signals associated with the voices pronounced by the speakers SPK1 to SPK4 from the codeless earphones 300-1 to 300-4. The voice signals are signals associated with the voices pronounced for a specific time, and may be signals representing the voices of the plurality of speakers.

The voice processing device 200 may judge the voice source positions of the voice signals transmitted from the codeless earphones 300-1 to 300-4, and extract (or generate) the separated voice signals associated with the voices of the speakers SPK1 to SPK4 from the voice signals transmitted from the codeless earphones 300-1 to 300-4 by performing voice source separation based on the voice source positions. That is, the separated voice signals that are described in the description correspond to the output voice data described with reference to FIGS. 1 to 10.

The voice processing device 200 may provide translations for the voices of the speakers SPK1 to SPK4 to the codeless earphones 300-1 to 300-4.

FIG. 12 illustrates a codeless earphone according to embodiments of the present disclosure. Referring to FIG. 12, the codeless earphones 300 representatively represent the codeless earphones 300-1 to 300-4 illustrated in FIG. 1.

The codeless earphone 300 may include a microphone unit 310, a speaker unit 320, a control unit 330, a communication unit 340, and a battery 350.

The microphone unit 310 may receive the voices, and generate the voice signals in response to the voices. According to an embodiment, the microphone unit 310 may detect vibrations of an air due to the voices, and generate the voice signals that are electrical signals corresponding to the vibrations in accordance with the results of the detection.

According to embodiments, the microphone unit 310 may include a plurality of microphones, and generate the voice signals in response to the voices of the plurality of microphones. For example, the codeless earphones 300 may generate a plurality of voice signals in response to one voice. In this case, since the microphones may have different dispositions, the voice signals generated by the respective microphones may have phase differences (or time delays) among them.

The speaker unit 320 may output the voices corresponding to the voice signals. According to embodiments, the speaker unit 320 may reproduce the voices associated with the voice signals by forming the vibrations corresponding to the voice signals.

The control unit 330 may control the overall operation of the codeless earphones 300. According to embodiments, the control unit 330 may include a processor having an arithmetic processing function. For example, the control unit 330 may include a central processing unit (CPU), a micro controller unit (MCU), a digital signal processor (DSP), an analog-to-digital converter (ADC), or a digital-to-analog converter (DAC), but is not limited thereto.

The control unit 330 may perform analog-to-digital conversion of the voice signals generated by the microphone unit 120. The converted digital voice signals may be output through the communication unit 340. Further, the control unit 330 may perform digital-to-analog conversion of the digital type translated voice signals received by the communication unit 340, and transmit the analog-converted translated voice signals to the speaker unit 320.

The communication unit 340 may send and receive data with the voice processing device 200A in accordance with the wireless communication method.

According to embodiments, the communication unit 340 may send and receive signals with the voice processing device 200A in accordance with the wireless communication method, such as WiFi, ZigBee, RFID, or NFC.

The communication unit 340 may transmit the voice signals to the voice processing device 200A, and receive the translated voice signals from the voice processing device 200A.

The battery 350 may provide a power that is necessary to operate the codeless earphone 300. According to embodiments, the battery 350 may provide the power to the microphone unit 310, the speaker unit 320, the control unit 330, and the communication unit 340 included in the codeless earphone 300.

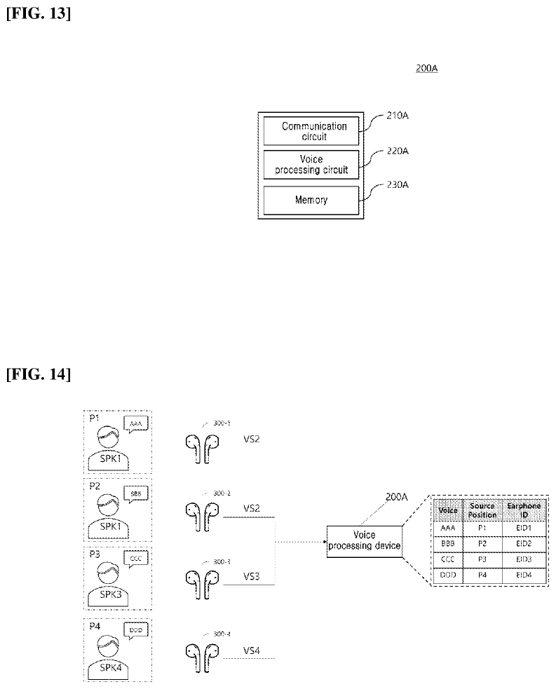

FIG. 13 illustrates a voice processing device according to embodiments of the present disclosure. The voice processing device 200A that is described with reference to FIG. 13 may perform the function of the voice processing device 200A described with reference to FIG. 2. Hereinafter, only the difference between them will be described.

Referring to FIG. 13, the voice processing device 200A may include a communication circuit 210A, a voice processing circuit 220A, and a memory 230A.

The communication circuit 210A may correspond to the voice data receiving circuit 210 and the voice data output circuit 240 described with reference to FIG. 2, the voice processing circuit 220A may correspond to the processor 230 described with reference to FIG. 2, and the memory 230A may correspond to the memory 220 described with reference to FIG. 2.

The communication circuit 210A may receive the voice signals associated with the voices of the speakers SPK1 to SPK4 from the codeless earphones 300-1 to 300-4. According to embodiments, the communication circuit 210A may include a plurality of communication modules, and the plurality of communication modules may perform pairing with the codeless earphones 300-1 to 300-4, respectively.

The communication circuit 210A may receive identifiers of the codeless earphones 300-1 to 300-4. The identifiers may be terminal IDs or MAC addresses of the codeless earphones 300-1 to 300-4, but are not limited thereto.

The communication circuit 210A may transmit the translation results to the codeless earphones 300-1 to 300-4. This will be described later.

The voice processing circuit 220A may process the voice signals. According to embodiments, the voice processing circuit 220A may extract (or generate) the separated voice signals associated with the voices of the speakers SPK1 to SPK4 by using the voice signals transmitted from the codeless earphones 300-1 to 300-4.

The voice processing circuit 220A may determine relative positions of voice sources for the codeless earphones 300-1 to 300-4, respectively, and generate the separated voice signals associated with the voices of the speakers SPK1 to SPK4 based on the voice source positions. For example, the voice processing circuit 220A may generate the first separated voice signal associated with the voice of the first speaker SPK1 based on the voice source positions of the voices.

Further, according to embodiments, the voice processing circuit 220A may match and store the voice source position information representing the positions of the voice sources with the separated voice signals. The voice source position information may mean the voice source position data described with reference to FIGS. 1 to 10.

The voice processing circuit 220A may perform translation of the voices of the speakers SPK1 to SPK4 by using the separated voice signals, and generate the translation results. The translation results may be text data or voice signals associated with the voices of the speakers SPK1 to SPK4, respectively, that are expressed in the target languages.

The memory 230A may store data that is necessary to operate the voice processing device 200A.

FIG. 14 is a diagram explaining an operation of a voice processing device according to embodiments of the present disclosure. Referring to FIG. 14, the speakers SPK1 to SPK4 positioned at the positions P1 to P4, respectively, may pronounce. For example, the first speaker SPK1 may pronounce a voice “AAA”, the second speaker SPK2 may pronounce a voice “BBB”, the third speaker SPK3 may pronounce a voice “CCC”, and the fourth speaker SPK4 may pronounce a voice “DDD”.

The voice processing device 200A may receive the voice signals VS1 to VS4 associated with the voices of the speakers SPK1 to SPK4, and generate the voice source position information representing voice source positions of the voices of the speakers SPK1 to SPK4. For example, the voice processing device 200A may generate and store first voice source position information representing the first voice source position “P1” that is the first voice source position of the voice of the first speaker SPK1.

The voice processing device 200A may generate the separated voice signals associated with the voices of the speakers SPK1 to SPK4 based on the voice source position information. For example, the voice processing device 200A may generate the separated voice signals associated with the voices “AAA”, “BBB”, “CCC”, and “DDD” from the received voice signals VS1 to VS4.

The voice processing device 200A may match and store the separated voice signals associated with the voices of the speakers SPK1 to SPK4 with the identifiers of the codeless earphones 300-1 to 300-4 worn by the speakers who have pronounced the voices. For example, the voice processing device 200A may generate the first separated voice signal associated with the voice “AAA” of the first speaker SPK1 by using the first voice signals VS1 transmitted from the first codeless earphone 300-1, and match and store the first separated voice signal with the identifier “EID1” of the first codeless earphone 300-1.

Through this, it is possible to grasp which of the codeless earphones 300-1 to 300-4 the speaker, having pronounced a specific voice, has worn. For example, since the first separated voice signal associated with the voice of the first speaker SPK1 is matched and stored with the first identifier of the first codeless earphone 300-1, it can be known that the first speaker SPK1 has worn the first codeless earphone 300-1.

Accordingly, as a result, the separated voice signals associated with the voices of the speakers SPK1 to SPK4, respectively, may be identified by the identifiers of the codeless earphones 300-1 to 300-4.

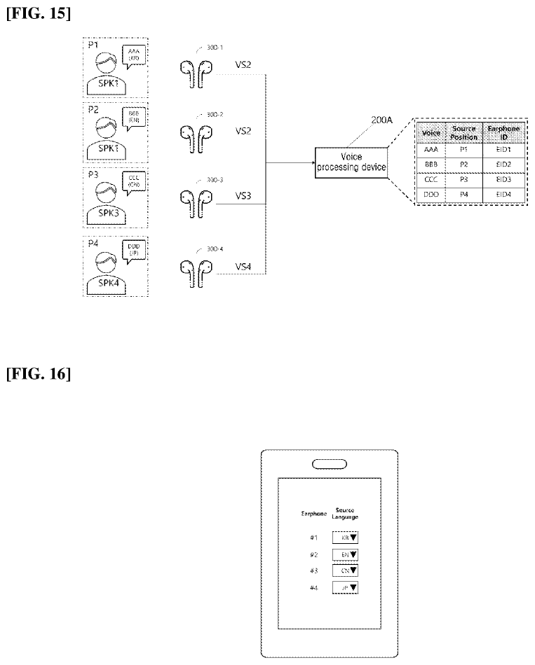

FIGS. 15 to 18 are diagrams explaining a translation function of a voice processing device according to embodiments of the present disclosure.

Referring to FIG. 15, the first speaker SPK1 pronounces a voice “AAA” in Korean (KR), the second speaker SPK2 pronounces a voice “BBB” in English (EN), the third speaker SPK3 pronounces a voice “CCC” in Chinese, and the fourth speaker SPK4 pronounces a voice “DDD” in Japanese (JP).

The voice processing device 200A may match and store the separated voice signals of the voices of the speakers SPK1 to SPK4 with the identifiers of the codeless earphones 300-1 to 300-4 worn by the speakers having pronounced the respective voices.

According to embodiments, the voice processing device 200A may generate and store the voice source position information representing the voice source positions of the voices of the speakers SPK1 to SPK4.

The voice processing device 200A according to embodiments of the present disclosure may provide translations of the languages of the voices of the speakers SPK1 to SPK4 from the source languages to the target languages by using the separated voice signals associated with the voices of the speakers SPK1 to SPK4.

According to embodiments, the source languages and the target languages may be determined by codeless earphones 300-1 to 300-4. That is, the source languages and the target languages for the voices of the wearers of the codeless earphones 300-1 to 300-4 may be determined.

Referring to FIG. 16, the source languages may be set with respect to the codeless earphones 300-1 to 300-4. For example, the source languages for translating the languages of the speakers who wear the codeless earphones 300-1 to 300-4, respectively, may be set by using terminals that can interwork with the voice processing device 200A. The set values may be transmitted to the voice processing device 200A. The voice processing device 200A may store the source language information representing the source languages for translating the languages of the speakers who wear the codeless earphones 300-1 to 300-4, respectively.

The terminals may transmit, to the voice processing device 200A, the source language information representing the source languages for the codeless earphones 300-1 to 300-4, and the voice processing device may match and store the source language information with the identifiers of the codeless earphones 300-1 to 300-4.

Further, according to embodiments, the source language information about the codeless earphones 300-1 to 300-4 may be pre-stored in the voice processing device 200A.

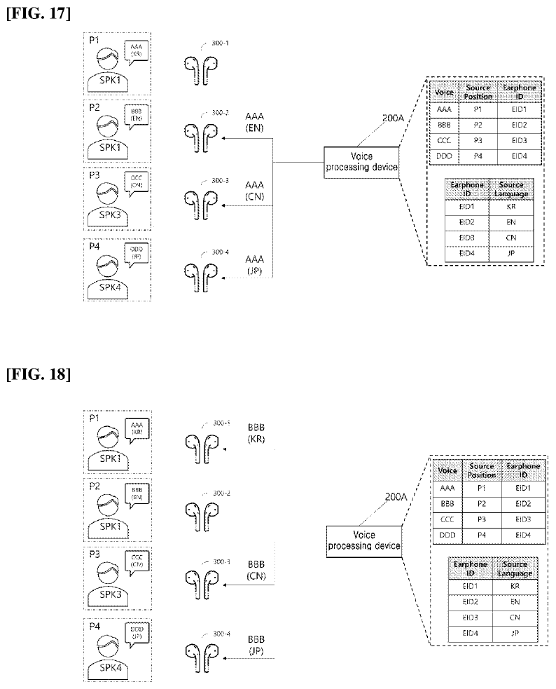

Referring to FIG. 17, the voice processing device 200A may determine the source languages and the target languages for translating the voices of the speakers SPK1 to SPK4 by using the identifiers of the codeless earphones 300-1 to 300-4 corresponding to the separated voice signals, respectively, generate the translation results for the respective voices of the speakers SPK1 to SPK4, and output the translation results.

According to embodiments, the voice processing device 200A may determine the source languages for translating the voices of the speakers SPK1 to SPK4 by reading the source language information corresponding to the codeless earphones 300-1 to 300-4 by using the identifiers of the codeless earphones 300-1 to 300-4. For example, the voice processing device 200A may read the first source language information corresponding to the first identifier EID1 from the memory 230A by using the first identifier EID1 of the first codeless earphone 300-1. The read first source language information indicates that the source language of the voice “AAA” of the first speaker SPK1 (e.g., wearer of the first codeless earphone 300-1) is Korean (KR).

According to embodiments, the voice processing device 200A may determine the target languages for the codeless earphones of the translation targets based on the source languages for the remaining codeless earphones that are not the translation targets among the codeless earphones 300-1 to 300-4. For example, the voice processing device 200A may determine the source languages of the remaining codeless earphones 100-2 to 100-4 excluding the first codeless earphone 300-1 as the target languages of the first codeless earphone 300-1. That is, the first target language information may indicate that the target languages of the voice “AAA” of the first speaker SPK1 (i.e., wearer of the first codeless earphone 300-1) are English (EN), Chinese (CN), and Japanese (JP) which are the remaining languages.

That is, the voice processing device 200A according to embodiments of the present disclosure may translate the language of the voice of the wearer (i.e., first speaker SPK1) of the first codeless earphone 300-1 among the plurality of codeless earphones 300-1 to 300-4 into the languages of the wearers (i.e., second speaker SPK2 to fourth speaker SPK4) of the remaining codeless earphones 100-2 to 100-4.

The voice processing device 200A may provide the translations for the voices of the speakers SPK1 to SPK4 based on the determined source languages and target languages. According to embodiments, the voice processing device 200A may generate the translation results for the voices of the speakers SPK1 to SPK4.

In the description, the translation result being output by the voice processing device 200A may be text data expressed in the target language or the voice signal associated with the voice pronounced by the target language, but is not limited thereto.

In the description, the generation of the translation results by the voice processing device 200A includes not only generation of the translation results by translating the languages through an arithmetic operation of the voice processing circuit 220A of the voice processing device 200A but also generation of the translation results by receiving the translation results from a server having a translation function through communication between the voice processing device 200A and the server.

For example, the voice processing circuit 220A may generate the translation results for the voices of the speakers SPK1 to SPK4 by executing a translation application stored in the memory 230A.

For example, the voice processing device 200A may transmit the separated voice signals, source language information, and target language information to the translators, and receive the translation results for the separated voice signals from the translators. The translators may mean an environment or a system that provides the translations for the languages. According to embodiments, the translators may output the translation results for the voices of the speakers SPK1 to SPK4 by using the separated voice signals, the source language information, and the target language information.

As illustrated in FIG. 17, for example, the voice processing device 200A may generate the translation result “AAA (EN)” for the voice of the first speaker SPK1 that is expressed in English (EN) by using the separated voice signal associated with the voice “AAA (KR)” of the first speaker SPK1 that is expressed in Korean (KR). Further, the voice processing device 200A may generate the translation results “AAA (CN)” and “AAA (JP)” for the voice of the first speaker SPK1 that is expressed in Chinese (CN) and Japanese (JP).

The voice processing device 200A may transmit the translation results for the voices of the speakers SPK1 to SPK4 to the codeless earphones 300-1 to 300-4. According to embodiments, the voice processing device 200A may transmit the translation results for the voices of the speakers SPK1 to SPK4 to the codeless earphones corresponding to the translated languages (i.e., target languages).

According to embodiments, the voice processing device 200A may read the identifier of the codeless earphone that matches the source language information representing the same language as the target language of the translation result with reference to the memory 230A, and transmit the translation result to the corresponding codeless earphone by using the read identifier.

For example, as illustrated in FIG. 17, the voice processing device 200A may transmit the translation result for the voice of the first speaker SPK1 to the codeless earphones 100-2 to 100-4.

Accordingly, the voice processing device 200A according to embodiments of the present disclosure may generate the translation results by translating the voices of the speakers SPK1 to SPK4, and transmit the generated translation results to the codeless earphones 300-1 to 300-4 worn by the speakers SPK1 to SPK4. Accordingly, even if the languages of the speakers SPK1 to SPK4 are different from one another, the speakers can communicate with one another in their languages through the voice processing system 10A.

Further, for example, as illustrated in FIG. 18, the voice processing device 200A may transmit the translation result for the voice of the second speaker SPK2 to the codeless earphones 100-1, 100-3, and 100-4.

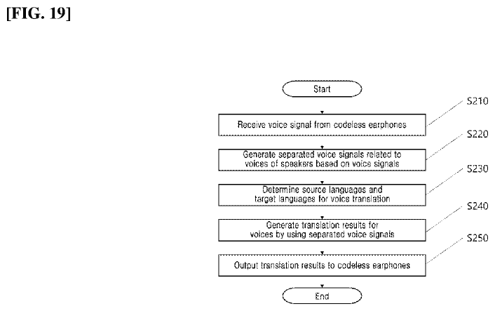

FIG. 19 is a flowchart illustrating an operation of a voice processing device according to embodiments of the present disclosure. Referring to FIG. 19, the voice processing device 200A may receive the voice signals associated with the voices of the speakers SPK1 to SPK4 from the codeless earphones 300-1 to 300-4 (S210). For example, the voice processing device 200A may receive the voice signals VS1 associated with the voices of the speakers SPK1 to SPK4 from the first codeless earphone 300-1 worn by the first speaker SPK1.

The voice processing device 200A may generate the separated voice signals associated with the voices of the speakers SPK1 to SPK4 from the voice signals transmitted from the codeless earphones 300-1 to 300-4 (S220). According to embodiments, the voice processing device 200A may generate the separated voice signals associated with the voices of the speakers SPK1 to SPK4 who wear the codeless earphones 300-1 to 300-4, respectively, based on the voice source positions of the voices corresponding to the voice signals transmitted from the codeless earphones 300-1 to 300-4.

The voice processing device 200A may determine the source languages and the target languages for the translations of the voices of the speakers SPK1 to SPK4 (S230). According to embodiments, the voice processing device 200A may determine the source languages by using the source language information matched and stored with the identifiers of the codeless earphones 300-1 to 300-4 with reference to the memory 230A, and also determine the target languages in accordance with the determined source languages.

The voice processing device 200A may generate the translation results for the voices of the speakers SPK1 to SPK4 by using the separated voice signals (S240). According to embodiments, the voice processing device 200A may generate the translation results through a self-translation algorithm stored in the voice processing device 200A, or transmit the separated voice signals and the target language and source language information to communicable translators and receive the translation results from the translators.

The voice processing device 200A may transmit the generated translation results to the codeless earphones 300-1 to 300-4 (S250). According to embodiments, the voice processing device 200A may transmit the translation results for the voices of the speakers SPK1 to SPK4 to the codeless earphones corresponding to the translated languages (i.e., target languages).

The voice processing system according to embodiments of the present disclosure may generate the voice signals associated with the voices of the speakers SPK1 to SPK4 by using the codeless earphones 300-1 to 300-4, and generate the separated voice signals associated with the voices of the speakers SPK1 to SPK4 by processing the voice signals.

Further, the voice processing system may translate the voices of the speakers SPK1 to SPK4 by using the separated voice signals, and output the translation results to the corresponding codeless earphones. Accordingly, even if the used languages of the speakers SPK1 to SPK4 are different from one another, the speakers SPK1 to SPK4 may pronounce the voices in their languages, and translate and receive the voices of the speakers who use the different languages into their own languages.

As described above, although embodiments have been described by the limited embodiments and drawings, those of ordinary skill in the corresponding technical field can make various corrections and modifications from the above description. For example, proper results can be achieved even if the described technologies are performed in a different order from that of the described method, and/or the described constituent elements, such as the system, structure, device, and circuit, are combined or assembled in a different form from that of the described method, or replaced by or substituted for other constituent elements or equivalents.

Accordingly, other implementations, other embodiments, and equivalents to the claims belong to the scope of the claims to be described later.

### INDUSTRIAL APPLICABILITY

Embodiments of the present disclosure relate to a device for processing voices and an operation method thereof.

1. A voice processing device comprising:
a voice data receiving circuit configured to receive input voice data associated with voices of speakers;
a memory configured to store source language data;
a voice data output circuit configured to output output voice data associated with the voices of the speakers; and
a processor configured to generate a control command for outputting the output voice data,
wherein the processor is further configured to:
generate first speaker position data representing a position of a first speaker among the speakers and first output voice data associated with a voice of the first speaker by using the input voice data,
read first source language data corresponding to the first speaker position data with reference to the memory, and
transmit, to the voice data output circuit, a control command for outputting the first output voice data to a translation environment for translating a first source language indicated by the first source language data.

2. The voice processing device of claim 1, wherein the input voice data is generated from voice signals generated by a plurality of microphones.

3. The voice processing device of claim 2,
wherein the processor is configured to generate the first speaker position data based on a distance between the plurality of microphones and times when the voice signals are received by the plurality of microphones.

4. The voice processing device of claim 1,
wherein the memory is configured to match and store position data corresponding to the source language data with the source language data, and
wherein the processor is configured to determine first position data corresponding to the first speaker position data among stored position data, and determine the first source language data matched and stored with the first position data among the source language data.

5. The voice processing device of claim 1,
wherein the processor is configured to convert the first output voice data associated with the voice of the first speaker into text data that is expressed in the first source language, and
wherein the voice data output circuit is configured to transmit the text data converted under the control of the processor to the translation environment.

6. The voice processing device of claim 1,
wherein the processor is configured to:
generate second speaker position data representing a position of a second speaker among the speakers by using the input voice data,
read second source language data corresponding to the second speaker position data with reference to the memory, and
transmit, to the voice data output circuit, the control command for outputting the first output voice data to a translation environment for translating the first source language into a second source language indicated by the second source language data.

7. The voice processing device of claim 6,
wherein the processor is configured to:
generate second output voice data associated with a voice of the second speaker by using the input voice data, and
transmit, to the voice data output circuit, the control command for outputting the first output voice data to a translation environment for translating the second source language into the first source language.

8. A voice processing system comprising a plurality of codeless earphones and a voice processing device,
wherein each of the plurality of codeless earphones includes:
a microphone unit configured to generate voice signals associated with voices pronounced by speakers, a communication unit configured to transmit the voice signals, and a speaker unit configured to reproduce voices, and
wherein the voice processing device includes:
a communication circuit configured to receive the voice signals transmitted from the plurality of codeless earphones;
a voice processing circuit configured to generate a first separated voice signal associated with a voice of a first speaker among the speakers from first voice signals transmitted from a first codeless earphone among the plurality of codeless earphones, and generate a first translated voice signal by translating the first separated voice signal;
a memory; and
a communication circuit configured to transmit the first translated voice signal to the remaining codeless earphones excluding the first codeless earphone among the plurality of codeless earphones.

9. The voice processing system of claim 8,
wherein the first translated voice signal is a voice signal associated with a voice obtained by translating the voice of the first speaker.

10. The voice processing system of claim 8,
wherein the microphone unit of each of the plurality of codeless earphones comprises a plurality of microphones, and
wherein the plurality of microphones are configured to generate the voice signal in response to the voices of the speakers.

11. The voice processing system of claim 8,
wherein the voice processing circuit is configured to:
judge voice source positions of the voices of the speakers based on a time delay between the first voice signals transmitted from the first codeless earphone, and
generate the first separated voice signal associated with the voice of the first speaker based on the judged voice source positions.

12. The voice processing system of claim 11,
wherein the first separated voice signal is a signal associated with a voice having a voice source position closest to the first codeless earphone among the voices of the speakers.

13. The voice processing system of claim 8,
wherein the communication circuit is configured to receive identifiers of the plurality of codeless earphones from the plurality of codeless earphones, and
wherein the voice processing circuit is configured to match and store, in the memory, the identifiers of the plurality of codeless earphones with source language information representing languages of the voices of the speakers who wear the codeless earphones.

14. The voice processing system of claim 13,
wherein the voice processing circuit is configured to: translate a language of the first separated voice signal into a language of the voice of the speaker who wears a second codeless earphone among the plurality of codeless earphones by using the identifiers and the source language information, and generate the first translated voice signal.

15. The voice processing system of claim 14,
wherein the voice processing circuit is configured to transmit the first translated voice signal to the second codeless earphone.
